(19) United States
(12) Patent Application Publication
(10) Pub. No.: US 2026/0017289 A1
(43) Pub. Date: Jan. 15, 2026

(54) MANUAL AND AUTOMATIC MAP TILT CONSOLIDATOR

(71) Applicant: Snap Inc, Santa Monica, CA (US)

(72) Inventors: Nathan Kenneth Boyd, Los Angeles, CA (US); Brett Camper, Brooklyn, NY (US); Yuanlong Gu, Fairview, NJ (US); Robert Derui Lin, Jersey City, NJ (US); Daniel Rakhamimov, Brooklyn, NY (US); Suraj Vindana Samaranayake, New York, NY (US); Luka Zuanovié, London (GB)

(21) Appl. No.: 18/767,717

(22) Filed: Jul. 9, 2024

(51) Int. Cl. G06F 16/29; G06F 3/04845

(52) U.S. Cl. CPC G06F 16/29; G06F 3/04845

(57) ABSTRACT

Zoom and tilt operations are performed on a map display based on a predetermined relationship between zooming and tilting that is defined by a plurality of zoom-tilt transition points. If user zoom input is received after a user has tilted the map representation to a user-selected tilt angle, a next zoom-tilt transition point in the specified relationship, in the zoom direction, is determined. The display of the map representation is then updated at a rate of tilt and zoom that is based at least in part on the user zoom input, and the difference between the next zoom-tilt transition point and the initial zoom level and the user-selected tilt angle.

### BACKGROUND

Viewing of a virtual landscape, such as an online map, can take place with different virtual camera orientations. Most map applications have a top-down two-dimensional (2D) view that permits a user to zoom into or out of the map so that more or less details are shown. Some map applications include a tilt function, in which the flat 2D view is tilted (pitched) upward or downward from the perspective of the viewer, and the landscape is rendered in an isometric or three-dimensional (3D) view. In some cases, a street-level view may also be provided.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some non-limiting examples are illustrated in the figures of the accompanying drawings in which:

FIG. 1 is a diagrammatic representation of a networked environment in which the present disclosure may be deployed, according to some examples.

FIG. 2 is a diagrammatic representation of a digital interaction system that has both client-side and server-side functionality, according to some examples.

FIG. 3 is a diagrammatic representation of a data structure as maintained in a database, according to some examples.

FIG. 4 is a schematic side view illustrating virtual camera tilting and zooming over a landscape, according to some examples.

FIG. 5 is graph showing the predetermined relationship between tilt and zoom in a single-segment implementation, according to some examples.

FIG. 6 is a graph showing the predetermined relationship between tilt and zoom in a multi-segment implementation, according to some examples.

FIG. 7A, FIG. 7B and FIG. 7C are representations of a map display and user interface on the screen of a user system, in which a user is providing tilt input, according to some examples.

FIG. 8A shows a zoomed-out map display and user interface, according to some examples.

FIG. 8B shows a zoomed-in map display and user interface, according to some examples.

FIG. 9 illustrates an aspect of the subject matter in accordance with one embodiment.

FIG. 10 is a diagrammatic representation of a machine in the form of a computer system within which a set of instructions may be executed to cause the machine to perform any one or more of the methodologies discussed herein, according to some examples.

FIG. 11 is a block diagram showing a software architecture within which examples may be implemented.

### DETAILED DESCRIPTION

Disclosed is a combined tilt and zoom feature, in which the tilt angle of a virtual camera in a map application depends on the zoom level. The tilt will normally be zero (top-down) when the map is zoomed out beyond a certain degree. As the user zooms into the map, the tilt angle will increase until a certain maximum tilt angle is reached, at which point any further zooming in will not result in additional tilt.

The relationship between the zoom level and tilt angle can be specified in a curve having more than one segment, in which the rate at which the tilt angle changes in response to zoom input can vary, so that, for example, the virtual camera tilts more slowly initially and then tilts more quickly as the user zooms in beyond a certain point.

The user can set a temporary custom tilt angle at any zoom level, and doing so will not affect the zoom level since the user is presumably satisfied with the current zoom level. If the user zooms in after adjusting the tilt angle from the tilt angle specified by the application or system for that zoom level, the amount of tilt will revert slowly to the system tilt angle as the user continues to zoom in or out. In some cases where the user has tilted beyond a particular threshold, that out-of-range tilt angle will be maintained regardless of subsequent zoom inputs.

In some examples, this feature is implemented in an application on a user system 102 such as a mobile device 114 or a computer client device 118, as described in more detail below, although the use on other devices providing mapping functionality is also contemplated. This feature provides improved processing of user zoom and tilt inputs, by providing custom tilt angles that return smoothly and predictably to defined system zoom and tilt relationships. This accommodates user customization in a manner that does not create sudden returns to system-defined zoom and tilt levels, reducing the amount of user input to provide an integrated automatic and manual zooming and tilting experience. By seamlessly accommodating both system and custom levels, less adjustment or readjustment of tilt angles by the user occurs. This provides benefits in terms of computer processing and power resources used.

### NETWORKED COMPUTING ENVIRONMENT

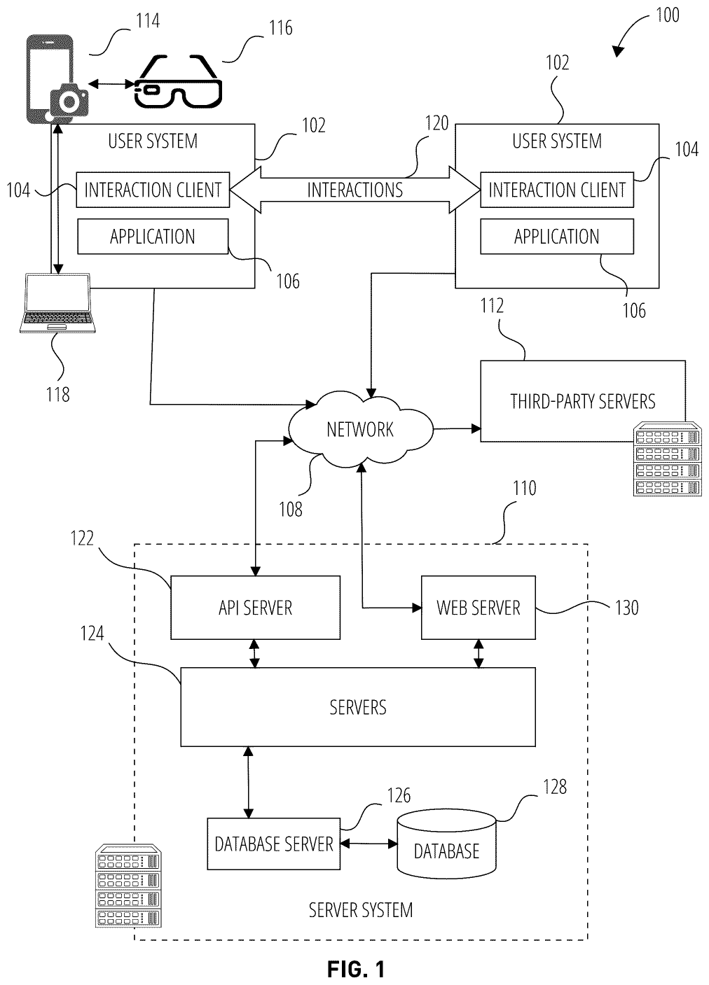

FIG. 1 is a block diagram showing an example digital interaction system 100 for facilitating interactions and engagements (e.g., exchanging text messages, conducting text audio and video calls, or playing games) over a network. The digital interaction system 100 includes multiple user systems 102, each of which hosts multiple applications, including an interaction client 104 and other applications 106. Each interaction client 104 is communicatively coupled, via one or more networks including a network 108 (e.g., the Internet), to other instances of the interaction client 104 (e.g., hosted on respective other user systems 102), a server system 110 and third-party servers 112). An interaction client 104 can also communicate with locally hosted applications 106 using Applications Program Interfaces (APIs).

Each user system 102 may include multiple user devices, such as a mobile device 114, head-wearable apparatus 116, and a computer client device 118 that are communicatively connected to exchange data and messages.

An interaction client 104 interacts with other interaction clients 104 and with the server system 110 via the network 108. The data exchanged between the interaction clients 104 (e.g., interactions 120) and between the interaction clients 104 and the server system 110 includes functions (e.g., commands to invoke functions) and payload data (e.g., text, audio, video, or other multimedia data).

The server system 110 provides server-side functionality via the network 108 to the interaction clients 104. While certain functions of the digital interaction system 100 are described herein as being performed by either an interaction client 104 or by the server system 110, the location of certain functionality either within the interaction client 104 or the server system 110 may be a design choice. For example, it may be technically preferable to initially deploy particular technology and functionality within the server system 110 but to later migrate this technology and functionality to the interaction client 104 where a user system 102 has sufficient processing capacity.

The server system 110 supports various services and operations that are provided to the interaction clients 104. Such operations include transmitting data to, receiving data from, and processing data generated by the interaction clients 104. This data may include message content, client device information, geolocation information, digital effects (e.g., media augmentation and overlays), message content persistence conditions, entity relationship information, and live event information. Data exchanges within the digital interaction system 100 are invoked and controlled through functions available via user interfaces (UIs) of the interaction clients 104.

Turning now specifically to the server system 110, an Application Program Interface (API) server 122 is coupled to and provides programmatic interfaces to servers 124, making the functions of the servers 124 accessible to interaction clients 104, other applications 106 and third-party server 112. The servers 124 are communicatively coupled to a database server 126, facilitating access to a database 128 that stores data associated with interactions processed by the servers 124. Similarly, a web server 130 is coupled to the servers 124 and provides web-based interfaces to the servers 124. To this end, the web server 130 processes incoming network requests over the Hypertext Transfer Protocol (HTTP) and several other related protocols.

The Application Program Interface (API) server 122 receives and transmits interaction data (e.g., commands and message payloads) between the servers 124 and the user systems 102 (and, for example, interaction clients 104 and other application 106) and the third-party server 112. Specifically, the Application Program Interface (API) server 122 provides a set of interfaces (e.g., routines and protocols) that can be called or queried by the interaction client 104 and other applications 106 to invoke functionality of the servers 124. The Application Program Interface (API) server 122 exposes various functions supported by the servers 124, including account registration; login functionality; the sending of interaction data, via the servers 124, from a particular interaction client 104 to another interaction client 104; the communication of media files (e.g., images or video) from an interaction client 104 to the servers 124; the settings of a collection of media data (e.g., a narrative); the retrieval of a list of friends of a user of a user system 102; the retrieval of messages and content; the addition and deletion of entities (e.g., friends) to an entity relationship graph (e.g., the entity graph 308); the location of friends within an entity relationship graph; and opening an application event (e.g., relating to the interaction client 104).

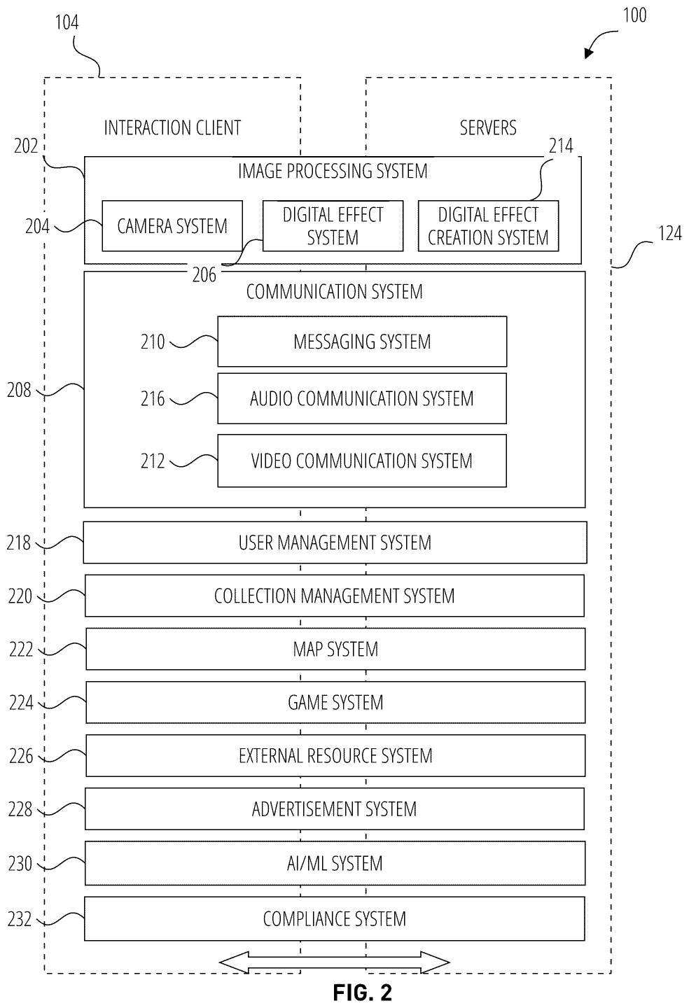

The servers 124 host multiple systems and subsystems, described below with reference to FIG. 2.

### SYSTEM ARCHITECTURE

FIG. 2 is a block diagram illustrating further details regarding the digital interaction system 100, according to some examples. Specifically, the digital interaction system 100 is shown to comprise the interaction client 104 and the servers 124. The digital interaction system 100 embodies multiple subsystems, which are supported on the client-side by the interaction client 104 and on the server-side by the servers 124. In some examples, these subsystems are implemented as microservices. A microservice subsystem (e.g., a microservice application) may have components that enable it to operate independently and communicate with other services. Example components of microservice subsystem may include:
Function logic: The function logic implements the functionality of the microservice subsystem, representing a specific capability or function that the microservice provides.
API interface: Microservices may communicate with each other components through well-defined APIs or interfaces, using lightweight protocols such as REST or messaging.
The API interface defines the inputs and outputs of the microservice subsystem and how it interacts with other microservice subsystems of the digital interaction system 100.
Data storage: A microservice subsystem may be responsible for its own data storage, which may be in the form of a database, cache, or other storage mechanism (e.g., using the database server 126 and database 128). This enables a microservice subsystem to operate independently of other microservices of the digital interaction system 100.
Service discovery: Microservice subsystems may find and communicate with other microservice subsystems of the digital interaction system 100. Service discovery mechanisms enable microservice subsystems to locate and communicate with other microservice subsystems in a scalable and efficient way.
Monitoring and logging: Microservice subsystems may need to be monitored and logged to ensure availability and performance. Monitoring and logging mechanisms enable the tracking of health and performance of a microservice subsystem.

In some examples, the digital interaction system 100 may employ a monolithic architecture, a service-oriented architecture (SOA), a function-as-a-service (FaaS) architecture, or a modular architecture:

Example subsystems are discussed below.

An image processing system 202 provides various functions that enable a user to capture and modify (e.g., augment, annotate or otherwise edit) media content associated with a message.

A camera system 204 includes control software (e.g., in a camera application) that interacts with and controls hardware camera hardware (e.g., directly or via operating system controls) of the user system 102 to modify real-time images captured and displayed via the interaction client 104.

The digital effect system 206 provides functions related to the generation and publishing of digital effects (e.g., media overlays) for images captured in real-time by cameras of the user system 102 or retrieved from memory of the user system 102. For example, the digital effect system 206 operatively selects, presents, and displays digital effects (e.g., media overlays such as image filters or modifications) to the interaction client 104 for the modification of real-time images received via the camera system 204 or stored images retrieved from memory 1108 of a user system 102. These digital effects are selected by the digital effect system 206 and presented to a user of an interaction client 104, based on a number of inputs and data, such as for example:
Geolocation of the user system 102; and
Entity relationship information of the user of the user system 102.

Digital effects may include audio and visual content and visual effects. Examples of audio and visual content include pictures, texts, logos, animations, and sound effects. Examples of visual effects include color overlays and media overlays. The audio and visual content or the visual effects can be applied to a media content item (e.g., a photo or video) at user system 102 for communication in a message, or applied to video content, such as a video content stream or feed transmitted from an interaction client 104. As such, the image processing system 202 may interact with, and support, the various subsystems of the communication system 208, such as the messaging system 210 and the video communication system 212.

A media overlay may include text or image data that can be overlaid on top of a photograph taken by the user system 102 or a video stream produced by the user system 102. In some examples, the media overlay may be a location overlay (e.g., Venice beach), a name of a live event, or a name of a merchant overlay (e.g., Beach Coffee House). In further examples, the image processing system 202 uses the geolocation of the user system 102 to identify a media overlay that includes the name of a merchant at the geolocation of the user system 102. The media overlay may include other indicia associated with the merchant. The media overlays may be stored in the databases 128 and accessed through the database server 126.

The image processing system 202 provides a user-based publication platform that enables users to select a geolocation on a map and upload content associated with the selected geolocation. The user may also specify circumstances under which a particular media overlay should be offered to other users. The image processing system 202 generates a media overlay that includes the uploaded content and associates the uploaded content with the selected gcolocation.

The digital effect creation system 214 supports augmented reality developer platforms and includes an application for content creators (e.g., artists and developers) to create and publish digital effects (e.g., augmented reality experiences) of the interaction client 104. The digital effect creation system 214 provides a library of built-in features and tools to content creators including, for example custom shaders, tracking technology, and templates.

In some examples, the digital effect creation system 214 provides a merchant-based publication platform that enables merchants to select a particular digital effect associated with a geolocation via a bidding process. For example, the digital effect creation system 214 associates a media overlay of the highest bidding merchant with a corresponding geolocation for a predefined amount of time.

A communication system 208 is responsible for enabling and processing multiple forms of communication and interaction within the digital interaction system 100 and includes a messaging system 210, an audio communication system 216, and a video communication system 212. The messaging system 210 is responsible, in some examples, for enforcing the temporary or time-limited access to content by the interaction clients 104. The messaging system 210 incorporates multiple timers that, based on duration and display parameters associated with a message or collection of messages (e.g., a narrative), selectively enable access (e.g., for presentation and display) to messages and associated content via the interaction client 104. The audio communication system 216 enables and supports audio communications (e.g., real-time audio chat) between multiple interaction clients 104. Similarly, the video communication system 212 enables and supports video communications (e.g., real-time video chat) between multiple interaction clients 104.

A user management system 218 is operationally responsible for the management of user data and profiles, and maintains entity information (e.g., stored in entity tables 306, entity graphs 308 and profile data 302) regarding users and relationships between users of the digital interaction system 100.

A collection management system 220 is operationally responsible for managing sets or collections of media (e.g., collections of text, image video, and audio data). A collection of content (e.g., messages, including images, video, text, and audio) may be organized into an “event gallery” or an “event collection.” Such a collection may be made available for a specified time period, such as the duration of an event to which the content relates. For example, content relating to a music concert may be made available as a “concert collection” for the duration of that music concert. The collection management system 220 may also be responsible for publishing an icon that provides notification of a particular collection to the user interface of the interaction client 104. The collection management system 220 includes a curation function that allows a collection manager to manage and curate a particular collection of content. For example, the curation interface enables an event organizer to curate a collection of content relating to a specific event (e.g., delete inappropriate content or redundant messages). Additionally, the collection management system 220 employs machine vision (or image recognition technology) and content rules to curate a content collection automatically. In certain examples, compensation may be paid to a user to include user-generated content into a collection. In such cases, the collection management system 220 operates to automatically make payments to such users to use their content.

A map system 222 provides various geographic location (e.g., geolocation) functions and supports the presentation of map-based media content and messages by the interaction client 104. For example, the map system 222 enables the display of user icons or avatars (e.g., stored in profile data 302) on a map to indicate a current or past location of “friends” of a user, as well as media content (e.g., collections of messages including photographs and videos) generated by such friends, within the context of a map. For example, a message posted by a user to the digital interaction system 100 from a specific geographic location may be displayed within the context of a map at that particular location to “friends” of a specific user on a map interface of the interaction client 104. A user can furthermore share his or her location and status information (e.g., using an appropriate status avatar) with other users of the digital interaction system 100 via the interaction client 104, with this location and status information being similarly displayed within the context of a map interface of the interaction client 104 to selected users.

A game system 224 provides various gaming functions within the context of the interaction client 104. The interaction client 104 provides a game interface providing a list of available games that can be launched by a user within the context of the interaction client 104 and played with other users of the digital interaction system 100. The digital interaction system 100 further enables a particular user to invite other users to participate in the play of a specific game by issuing invitations to such other users from the interaction client 104. The interaction client 104 also supports audio, video, and text messaging (e.g., chats) within the context of gameplay, provides a leaderboard for the games, and supports the provision of in-game rewards (e.g., coins and items).

An external resource system 226 provides an interface for the interaction client 104 to communicate with remote servers (e.g., third-party servers 112) to launch or access external resources, i.e., applications or applets. Each third-party server 112 hosts, for example, a markup language (e.g., HTML5) based application or a small-scale version of an application (e.g., game, utility, payment, or ride-sharing application). The interaction client 104 may launch a web-based resource (e.g., application) by accessing the HTML5 file from the third-party servers 112 associated with the web-based resource. Applications hosted by third-party servers 112 are programmed in JavaScript leveraging a Software Development Kit (SDK) provided by the servers 124. The SDK includes Application Programming Interfaces (APIs) with functions that can be called or invoked by the web-based application. The servers 124 host a JavaScript library that provides a given external resource access to specific user data of the interaction client 104. HTML5 is an example of technology for programming games, but applications and resources programmed based on other technologies can be used.

An advertisement system 228 operationally enables the purchasing of advertisements by third parties for presentation to end-users via the interaction clients 104 and handles the delivery and presentation of these advertisements.

An artificial intelligence and machine learning system 230 provides a variety of services to different subsystems within the digital interaction system 100. For example, the artificial intelligence and machine learning system 230 operates with the image processing system 202 and the camera system 204 to analyze images and extract information such as objects, text, or faces. This information can then be used by the image processing system 202 to enhance, filter, or manipulate images. The artificial intelligence and machine learning system 230 may be used by the digital effect system 206 to generate modified content and augmented reality experiences, such as adding virtual objects or animations to real-world images. The communication system 208 and messaging system 210 may use the artificial intelligence and machine learning system 230 to analyze communication patterns and provide insights into how users interact with each other and provide intelligent message classification and tagging, such as categorizing messages based on sentiment or topic. The artificial intelligence and machine learning system 230 may also provide chatbot functionality to message interactions 120 between user systems 102 and between a user system 102 and the server system 110. The artificial intelligence and machine learning system 230 may also work with the audio communication system 216 to provide speech recognition and natural language processing capabilities, allowing users to interact with the digital interaction system 100 using voice commands.

A compliance system 232 facilitates compliance by the digital interaction system 100 with data privacy and other regulations, including for example the California Consumer Privacy Act (CCPA), General Data Protection Regulation (GDPR), and Digital Services Act (DSA). The compliance system 232 comprises several components that address data privacy, protection, and user rights, ensuring a secure environment for user data. A data collection and storage component securely handles user data, using encryption and enforcing data retention policies. A data access and processing component provides controlled access to user data, ensuring compliant data processing and maintaining an audit trail. A data subject rights management component facilitates user rights requests in accordance with privacy regulations, while the data breach detection and response component detects and responds to data breaches in a timely and compliant manner. The compliance system 232 also incorporates opt-in/opt-out management and privacy controls across the digital interaction system 100, empowering users to manage their data preferences. The compliance system 232 is designed to handle sensitive data by obtaining explicit consent, implementing strict access controls and in accordance with applicable laws.

### DATA ARCHITECTURE

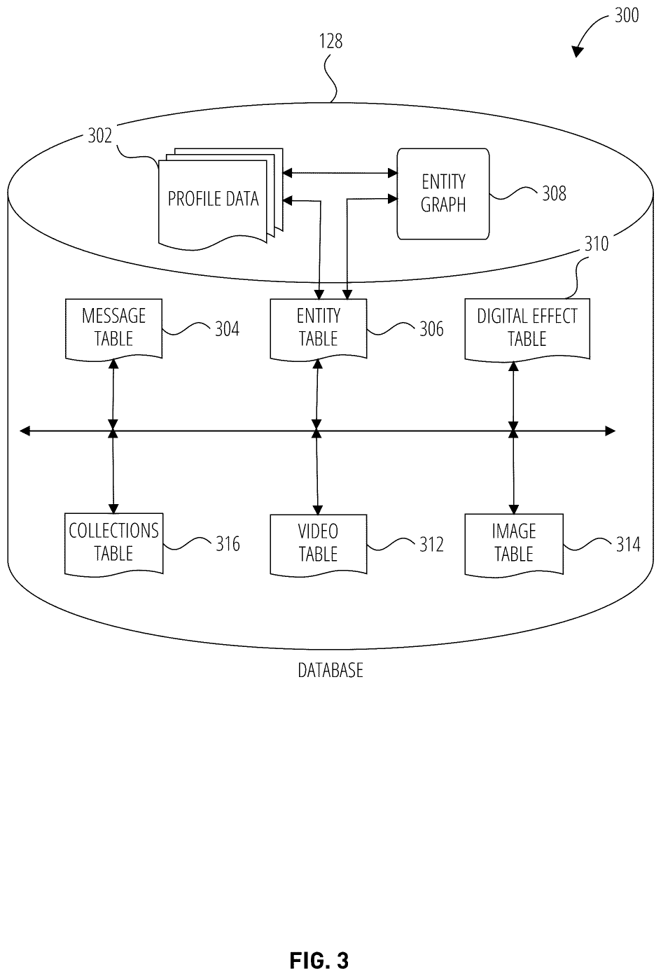

FIG. 3 is a schematic diagram illustrating data structures 300, which may be stored in the database 128 of the server system 110, according to certain examples. While the content of the database 128 is shown to comprise multiple tables, it will be appreciated that the data could be stored in other types of data structures (e.g., as an object-oriented database).

The database 128 includes message data stored within a message table 304. This message data includes at least message sender data, message recipient (or receiver) data, and a payload. Further details regarding information that may be included in a message, and included within the message data stored in the message table 304, are described below with reference to FIG. 3.

An entity table 306 stores entity data, and is linked (e.g., referentially) to an entity graph 308 and profile data 302. Entities for which records are maintained within the entity table 306 may include individuals, corporate entities, organizations, objects, places, events, and so forth. Regardless of entity type, any entity regarding which the server system 110 stores data may be a recognized entity. Each entity is provided with a unique identifier, as well as an entity type identifier (not shown).

The entity graph 308 stores information regarding relationships and associations between entities. Such relationships may be social, professional (e.g., work at a common corporation or organization), interest-based, or activity-based, merely for example. Certain relationships between entities may be unidirectional, such as a subscription by an individual user to digital content of a commercial or publishing user (e.g., a newspaper or other digital media outlet, or a brand). Other relationships may be bidirectional, such as a “friend” relationship between individual users of the digital interaction system 100.

Certain permissions and relationships may be attached to each relationship, and to each direction of a relationship. For example, a bidirectional relationship (e.g., a friend relationship between individual users) may include authorization for the publication of digital content items between the individual users, but may impose certain restrictions or filters on the publication of such digital content items (e.g., based on content characteristics, location data or time of day data). Similarly, a subscription relationship between an individual user and a commercial user may impose different degrees of restrictions on the publication of digital content from the commercial user to the individual user, and may significantly restrict or block the publication of digital content from the individual user to the commercial user. A particular user, as an example of an entity, may record certain restrictions (e.g., by way of privacy settings) in a record for that entity within the entity table 306. Such privacy settings may be applied to all types of relationships within the context of the digital interaction system 100, or may selectively be applied to certain types of relationships.

The profile data 302 stores multiple types of profile data about a particular entity. The profile data 302 may be selectively used and presented to other users of the digital interaction system 100 based on privacy settings specified by a particular entity. Where the entity is an individual, the profile data 302 includes, for example, a username, telephone number, address, settings (e.g., notification and privacy settings), as well as a user-selected avatar representation (or collection of such avatar representations). A particular user may then selectively include one or more of these avatar representations within the content of messages communicated via the digital interaction system 100, and on map interfaces displayed by interaction clients 104 to other users. The collection of avatar representations may include “status avatars,” which present a graphical representation of a status or activity that the user may select to communicate at a particular time.

Where the entity is a group, the profile data 302 for the group may similarly include one or more avatar representations associated with the group, in addition to the group name, members, and various settings (e.g., notifications) for the relevant group.

The database 128 also stores digital effect data, such as overlays or filters, in a digital effect table 310. The digital effect data is associated with and applied to videos (for which data is stored in a video table 312) and images (for which data is stored in an image table 314).

Filters, in some examples, are overlays that are displayed as overlaid on an image or video during presentation to a recipient user. Filters may be of various types, including user-selected filters from a set of filters presented to a sending user by the interaction client 104 when the sending user is composing a message. Other types of filters include geolocation filters (also known as geo-filters), which may be presented to a sending user based on geographic location. For example, geolocation filters specific to a neighborhood or special location may be presented within a user interface by the interaction client 104, based on geolocation information determined by a Global Positioning System (GPS) unit of the user system 102.

Another type of filter is a data filter, which may be selectively presented to a sending user by the interaction client 104 based on other inputs or information gathered by the user system 102 during the message creation process. Examples of data filters include current temperature at a specific location, a current speed at which a sending user is traveling, battery life for a user system 102, or the current time.

Other digital effect data that may be stored within the image table 314 includes augmented reality content items (e.g., corresponding to augmented reality experiences). An augmented reality content item may be a real-time special effect and sound that may be added to an image or a video.

A collections table 316 stores data regarding collections of messages and associated image, video, or audio data, which are compiled into a collection (e.g., a narrative or a gallery). The creation of a particular collection may be initiated by a particular user (e.g., each user for which a record is maintained in the entity table 306). A user may create a “personal collection” in the form of a collection of content that has been created and sent/broadcast by that user. To this end, the user interface of the interaction client 104 may include an icon that is user-selectable to enable a sending user to add specific content to his or her personal narrative.

A collection may also constitute a “live collection,” which is a collection of content from multiple users that is created manually, automatically, or using a combination of manual and automatic techniques. For example, a “live collection” may constitute a curated stream of user-submitted content from various locations and events. Users whose client devices have location services enabled and are at a common location event at a particular time may, for example, be presented with an option, via a user interface of the interaction client 104, to contribute content to a particular live collection. The live collection may be identified to the user by the interaction client 104, based on his or her location.

A further type of content collection is known as a “location collection,” which enables a user whose user system 102 is located within a specific geographic location (e.g., on a college or university campus) to contribute to a particular collection. In some examples, a contribution to a location collection may employ a second degree of authentication to verify that the end-user belongs to a specific organization or other entity (e.g., is a student on the university campus).

As mentioned above, the video table 312 stores video data that, in some examples, is associated with messages for which records are maintained within the message table 304. Similarly, the image table 314 stores image data associated with messages for which message data is stored in the entity table 306. The entity table 306 may associate various digital effects from the digital effect table 310 with various images and videos stored in the image table 314 and the video table 312.

The databases 128 also include map and map-related information, including points of interest, 3D representations of structures and objects, satellite and street imagery, and other data known in the online mapping art.

### MAP INTERFACE

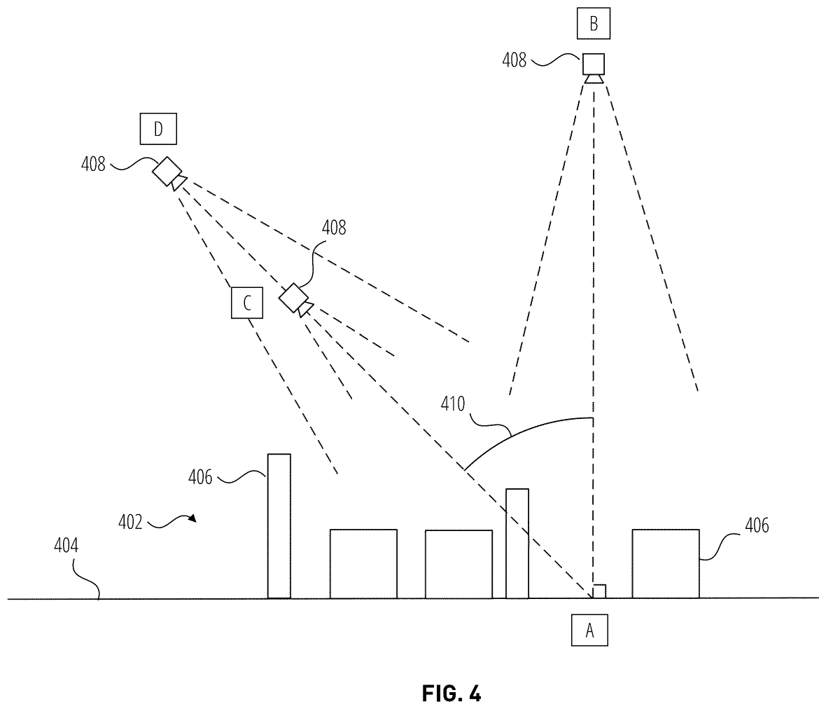

FIG. 4 is a schematic side view illustrating virtual camera tilting and zooming over a landscape, according to some examples. Several virtual cameras 408 are shown looking down onto a virtual landscape 402 including the ground 404 and buildings 406. The virtual landscape 402 is a representation of actual geographical features as in known map applications executing on a user system 102, but it can also be a completely virtual landscape 402.

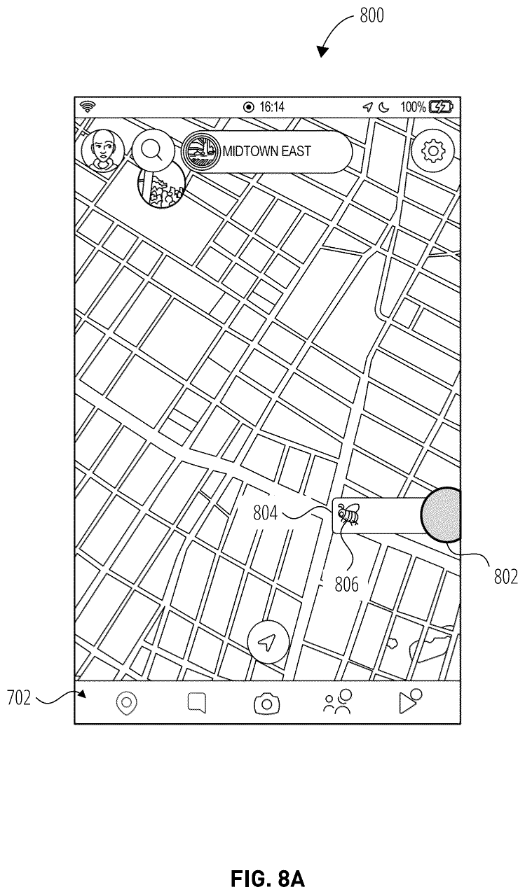

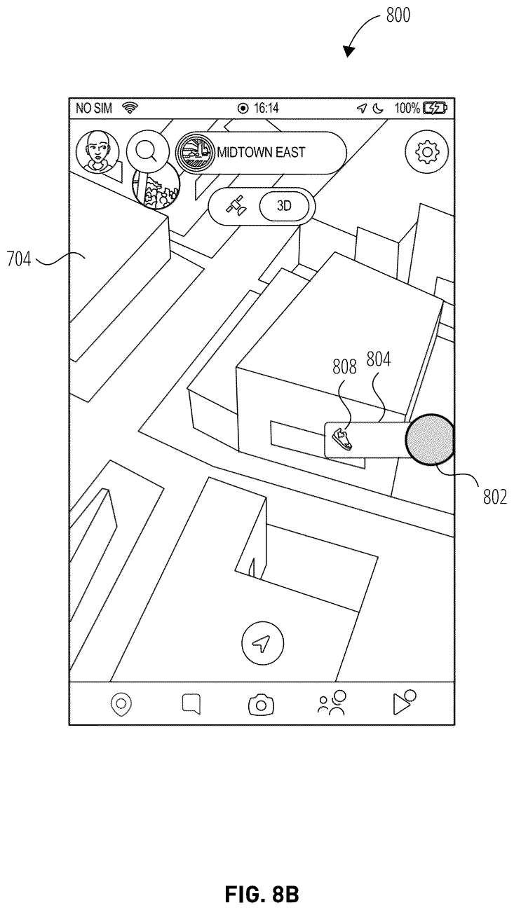

The virtual cameras 408 represent points of view of the virtual landscape 402 as shown on the display of a user system 102 as the user zooms and tilts to change their point of view of the virtual landscape 402. The point of view represented by the virtual camera 408 in position B is a top-down view with no tilt, such as for example shown in FIG. 8A. The view from position B is centered on point A on the ground 404 of the virtual landscape 402.

As the user system 102, in response to user input, zooms in from the point of view at position B, at a certain zoom level the user system 102 will cause the view of the virtual landscape to begin tilting downward to provide a perspective view of the virtual landscape 402, such as for example as represented by virtual camera 408 at position C. Compared to the view from position B, the view from position C is both zoomed in and tilted but is still centered on position A. Alternatively, from position B (or any other position), the user system 102, in response to tilt-only user input, will just tilt the point of view, for example to position D, where a perspective view is provided without zooming in compared to position B.

That is, in some examples, zooming in or out results in a change in tilt angle 410 as the zoom level varies, while manually tilting will not result in a change in zoom level.

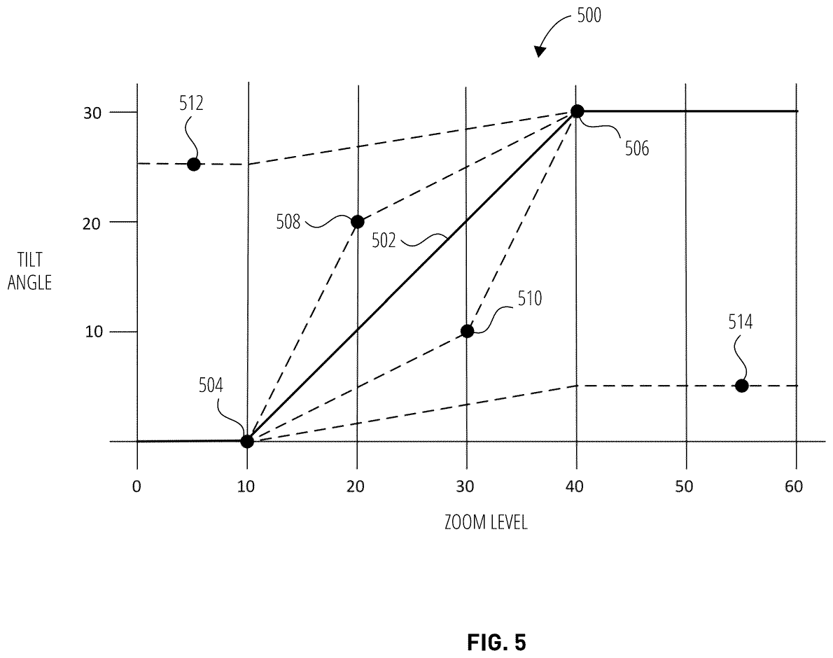

FIG. 5 is a graph 500 showing the predetermined relationship between tilt and zoom in a single-segment implementation. The graph 500 shows zoom level on the x-axis and the corresponding tilt angle on the y-axis. The tilt angle is represented in degrees, while the zoom level is a percentage value between 0 (completely zoomed out) and 100 (completely zoomed in). The predetermined relationship between the zoom level and the tilt angle (410), as defined by the user system 102 or an application 106 running on the user system 102, is illustrated by solid zoom-tilt line 502.

As can be seen when zoomed out between values of 0 and 10%, the tilt angle 410 is zero, which provides the top-down view corresponding to position B in FIG. 4. When the zoom level reaches transition point 504 at a zoom level of 10%, further zooming in by the user system 102 will result in the tilt angle increasing from zero to a value of 30 degrees at a zoom level of 40% at transition point 506. Further zooming in beyond 40% will not increase the tilt angle further in this example.

The segment of the zoom-tilt line 502 between transition point 504 and transition point 506 is linear in this example, but different curves could be provided. Also, the locations of the transition points 504, transition point 506 can vary.

A user can tilt the viewpoint manually, via the user system 102, at any zoom level. For example, the user can use touch and drag commands on a touch display of the user system 102 to adjust the tilt. For instance, at a 20% zoom level corresponding to a 10 degree tilt angle, the user can increase the tilt angle to 20 degrees (to user-selected tilt point 508) using touch and drag commands as described in more detail below. In another example, at a 30% zoom level corresponding to a 20 degree tilt angle, the user can manually decrease the tilt angle to 10 degrees (to user-selected tilt point 510) using the touch and drag commands as described in more detail below. Similar operations can be performed at a 5% zoom level (user-selected tilt point 512) and 55% zoom level (user-selected tilt point 514).

How the application 106 reacts to zoom inputs after user input to tilt the viewpoint away from the zoom-tilt line 502 will depend on where the user-selected tilt point is on the graph 500 and its relationship to the zoom-tilt line 502, in particular as regards the adjacent transition points on the zoom-tilt line 502 on each side of the user-selected tilt point.

In the case of user-selected tilt points 508, 510, it can be seen that these points are both located between transition point 504 and transition point 506 on the zoom axis and are also within the tilt range defined between transition points 504, transition point 506. If the user now provides input to zoom in or out, the user system 102 causes the tilt angle to revert smoothly along a line to the nearest transition point in the relevant direction, as shown by the dashed lines in FIG. 5. For example, from user-selected tilt point 508, if the user zooms out, the zoom level will decrease in a straight line to transition point 504, at which point additional zooming in either direction will follow the zoom-tilt line 502. Similarly, from user-selected tilt point 510, if the user zooms in, the zoom level will increase in a straight line to transition point 506, at which point additional zooming in either direction will follow the zoom-tilt line 502.

Causing the tilt angle to revert smoothly along a line to a nearest transition point in the relevant direction prevents sudden changes in tilt angle as the user returns to zooming after selecting a custom tilt angle, while returning to the tilt-zoom regime defined in the application 106.

When the user-selected tilt point is not between two adjacent transition points on the tilt axis, the user system 102, upon receiving subsequent zoom input, will revert smoothly to the nearest transition point in the relevant direction. For example, from user-selected tilt point 512, in response to user input to zoom in, the tilt angle will not revert smoothly to user-selected tilt point 508, but will increase smoothly to the next transition point in the zoom-in direction, namely transition point 506. This prevents a change in tilt direction that would have occurred if the tilt angle had first decreased to user-selected tilt point 508 before increasing to transition point 506.

Similarly, from user-selected tilt point 514, in response to user input to zoom out, the user system 102 will not revert smoothly to user-selected tilt point 510, but will decrease smoothly to the next transition point in the zoom-out direction, namely transition point 504.

In the illustrated examples, the tilt angles corresponding to user-selected tilt points 508, 510 are kept constant by the user system 102 until the current zoom level reaches the next segment of the zoom-tilt line 502, at which the current tilt angle and zoom level are between adjacent transition points on the zoom-tilt line 502. As can be seen in FIG. 5, the tilt angle is unchanged from user-selected tilt point 512 until a zoom level of 10%, after which the tilt angle is increased smoothly by the user system 102 to transition point 506. Similarly, the tilt angle is unchanged from user-selected tilt point 514 until a zoom level of 40%, after which the tilt angle decreases smoothly to transition point 504.

In other examples, the tilt angle is not initially kept constant by the user system 102 in this manner for out-of-segment user-selected tilt points, but the tilt angle is adjusted smoothly to the next transition point in the relevant zoom direction, namely in a straight line from user-selected tilt point 512 to transition point 506 or in a straight line from user-selected tilt point 514 to transition point 504.

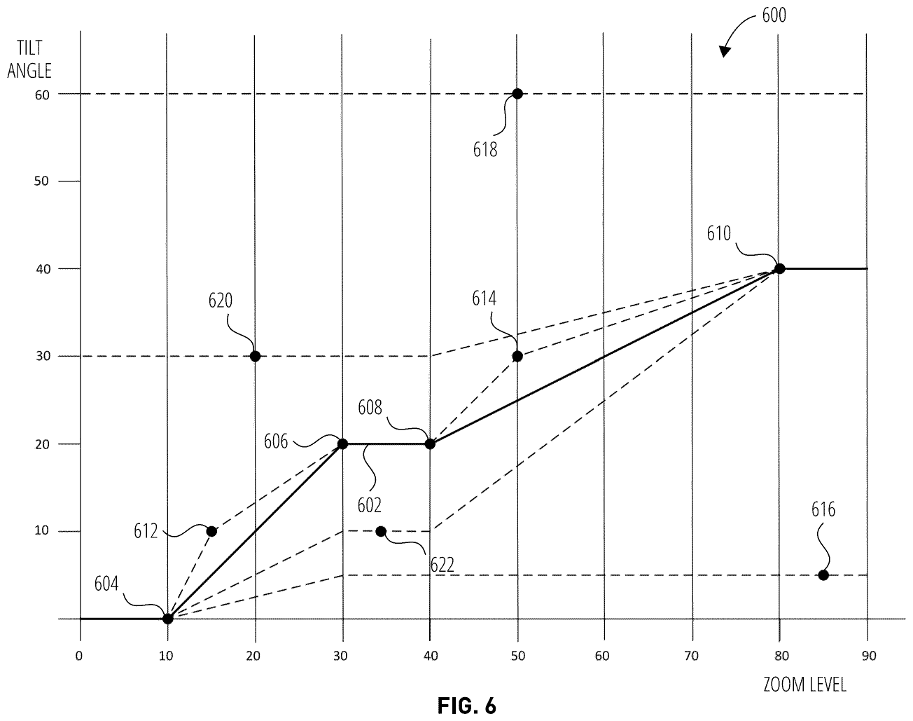

FIG. 6 is a graph 600 showing the predetermined relationship between tilt and zoom in a multi-segment implementation, according to some examples. In this example, the zoom-tilt line 602 in the graph 600 that defines the predetermined relationship between tilt and zoom includes multiple segments having different slopes, as defined by transition points 604, 606, 608 and 610. The slope of a segment is the rate at which the tilt angle will alter in response to zoom input.

In FIG. 6, zooming in or out from user-selected tilt point 612 will result in a smooth return to transition point 604 or transition point 606 of the corresponding segment of the zoom-tilt line 602 as described in FIG. 5 with respect to user-selected tilt point 508. Similarly, zooming in or out from user-selected tilt point 614 will result in a smooth return to transition point 608 or transition point 610.

User-selected tilt point 616 is outside the tilt range of any adjacent transition points. As user zoom input is received, the tilt angle will remain unchanged until the zoom level reaches a segment in which the current tilt angle and zoom value are between two transition points, at which point the tilt angle will return smoothly to the tilt angle associated with the next transition point in the direction of zoom. In the case of user-selected tilt point 616, this will be between transition point 606 and transition point 604 when zooming out. When zooming in from user-selected tilt point 616, the tilt angle remains constant, since a current zoom level and tilt angle will not reach a position in which they are between two adjacent transition points.

Similarly, the tilt angle from user-selected tilt point 620 remains unchanged when zooming out since a current zoom level and tilt angle will not reach a position in which they are between two adjacent transition points. When zooming in from user-selected tilt point 620, the tilt angle remains unchanged until it reaches the zoom level associated with transition point 608, at which point the tilt angle returns smoothly to transition point 610. In both cases, it will be noticed that the tilt angle passes across one or more segments without changing, due to the fact that the tilt angle does not fall within the tilt angle of two adjacent transition points until a later segment.

In other examples, instead or remaining constant initially in such circumstances, the tilt angle can immediately start changing towards the next highest tilt angle when zooming in or towards the next lowest tilt angle when zooming out. For user-selected tilt point 616 this will again be transition point 604 and for user-selected tilt point 620 this will again be transition point 610.

In some examples, instead of maintaining a constant tilt angle until current zoom-tilt values are between adjacent transition points, the tilt angle is maintained constant until it reaches the zoom level associated with the next transitions point, at which time the tilt angle is adjusted smoothly to the next transition point after than in the direction of zoom. For example, for user-selected tilt point 622, the tilt angle remains constant between a zoom level of 30% and a zoom level of 40%, associated with the segment defined by transition point 606 and transition point 608. Upon reaching transition point 606, the tilt level adjusts smoothly to the tilt level of transition point 610, even though the current zoom-tilt values have not and will not reach a position in which they are between two adjacent transition points.

If a user provides input that reverses the zoom direction after starting to zoom from a particular user-selected tilt point, the point at which the zoom direction changes will be treated as a new user-selected tilt point if the tilt and zoom levels at that point have not reached the zoom-tilt line 602. In the linear examples shown, at any tilt angle for a user-selected tilt point that is between adjacent transition points, the slope of any joint tilting and zooming is the slope between the user-selected tilt point and the next transition point in the selected zoom direction.

In some examples, when a user-selected tilt point is outside the tilt range defined by the zoom-tilt line 602, in FIG. 6 a tilt of 0 (transition point 604) to 40 degrees (transition point 610), such as user-selected tilt point 618, the tilt angle is maintained constant irrespective of the subsequently selected zoom level. In other examples, in such a case, the tilt angle is retained while zooming in but reverts to the transition point with the smallest tilt angle, such as transition point 604 when zooming out.

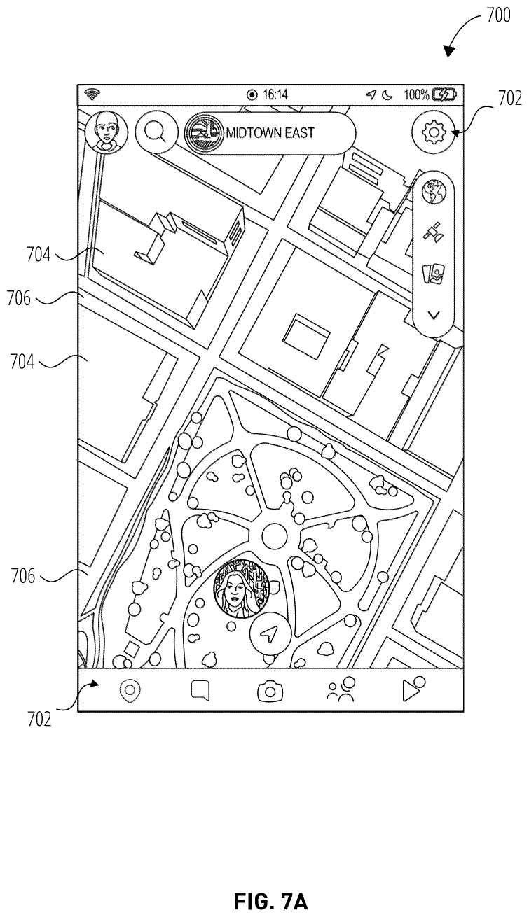

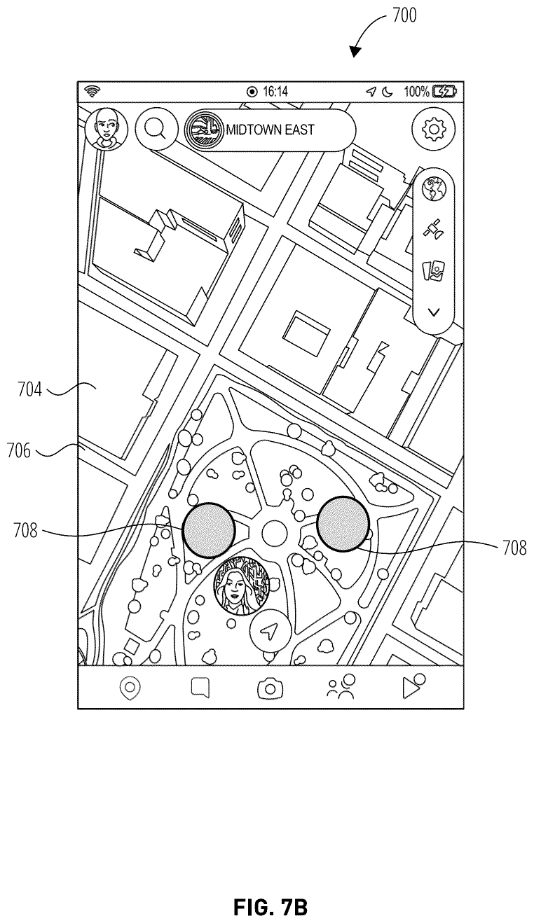

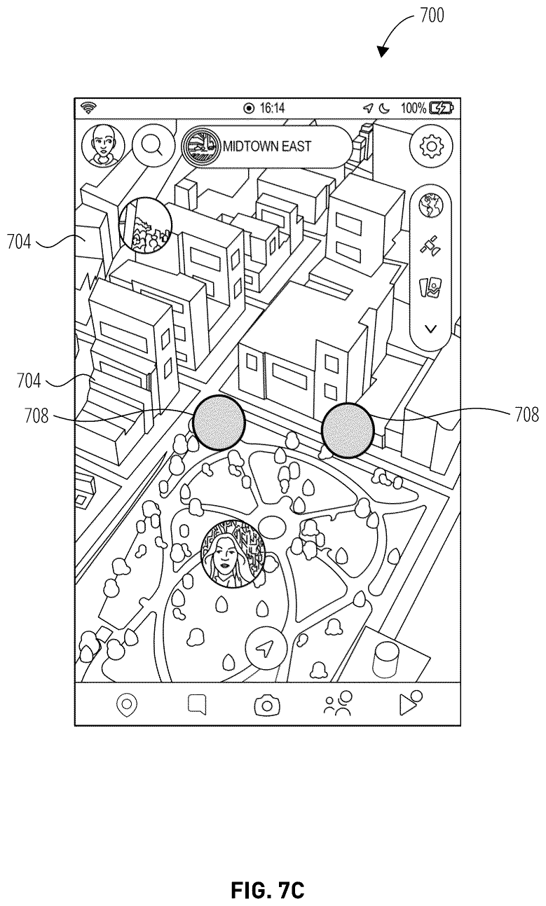

FIG. 7A, FIG. 7B and FIG. 7C are representations of a map display and user interface 700 on the screen of a user system 102, in which a user is providing tilt input, according to some examples. The user interface 700 includes various user interface elements 702 that are known for mobile devices 114 and for mapping applications. The user interface 700 in FIG. 7A and FIG. 7B shows an almost top-down view of an urban area, including buildings 704, streets 706, a park, and other features. A small tilt angle can be seen from the slight perspective view of the buildings 704.

In some examples, tilt input is received from a user by a double finger touch on the user interface 700 and a subsequent vertical swipe (up or down on a touchscreen display), as illustrated in FIG. 7B and FIG. 7C. Swiping up from the lower finger touch inputs 708 on the user interface 700 in FIG. 7B results in the user system 102 displaying the tilted view shown in FIG. 7C, in which the tilt angle 410 has been increased and the perspective view of the urban scene adjusted accordingly. In other examples, swiping down increases the tilt angle 410 instead of swiping up. In some examples, this relationship between swipe direction and tilt angle 410 can be set by user preference in an associated settings or preferences menu.

The change in degree of tilt depends on the length of the swipe (the tilt user input amount), based on a defined relationship between the distance on the screen and the resulting change in the degree of tilt.

FIG. 8A shows a zoomed-out map display and user interface 800 and FIG. 8B shows a zoomed-in map display and user interface 800, according to some examples. FIG. 8A and FIG. 8B illustrate user tilt input according to some examples. As shown in FIG. 8A, in response to a single finger touch input 802 at an edge of the display, the user system 102 pops out a zoom or height indicator 804 in the shape of a bar. Included on the bar is an icon that graphically represents the zoom level or height. In FIG. 8A, a bee icon 806 is shown, corresponding to a zoomed out top down (zero tilt) view of an urban area.

Swiping up from the finger touch input 802 in FIG. 8A provides a “zoom in” input to the user system 102 to increase the zoom level, which results in the zoomed-in and tilted view shown in FIG. 8B. In other examples, swiping down increases the zoom level instead of swiping up. In some examples, this relationship between swipe direction and zoom level can be set by user preference in an associated settings or preferences menu.

As can be seen in FIG. 8B, the icon in the height indicator 804 has changed to a shoe icon 808, illustrating a closer view of the urban area, in which details that are not visible in the view shown in FIG. 8A are presented, including buildings 704. The view in FIG. 8B is also tilted compared to the view in FIG. 8A. This tilting, in response to zoom input, results from the user system 102 causing the user interface 800 following a zoom-tilt line such as zoom-tilt lines 502, 602.

The change in the level of zoom depends on the length of the swipe (the zoom user input amount), based on a defined relationship between the distance on the screen and the resulting change in the level of zoom.

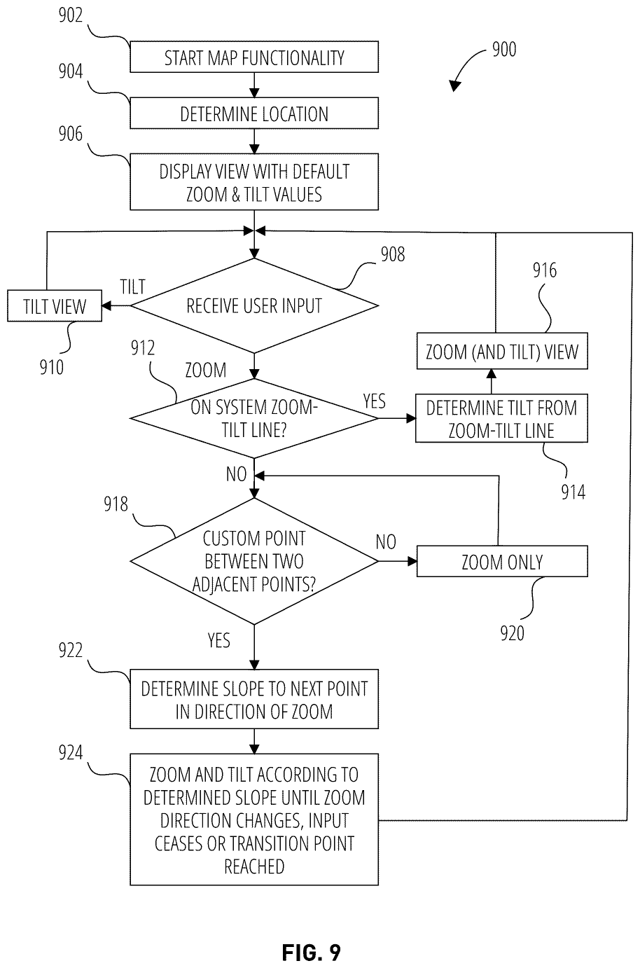

FIG. 9 is a flowchart 900 illustrating a tilt-zoom method, according to some examples. For explanatory purposes, the operations of the flowchart 900 are described herein as occurring in serial, or linearly. However, multiple operations of the flowchart 900 may occur in parallel. In addition, the operations of the flowchart 900 need not be performed in the order shown and/or one or more blocks of the flowchart 900 need not be performed and/or can be replaced by other operations.

Operations illustrated in FIG. 9 will typically execute on a computing device such as user mobile device 114 (user system 102). For the purposes of clarity, flowchart 900 is discussed herein with reference to such an example. Various implementations are, of course, possible, with some of the operations taking place in interaction server system 110 or with one application calling another application or SDK for the required functionality.

The flowchart 900 commences in operation 902 with the receipt of user input initiating mapping functionality, for example launching a mapping application or initiating mapping functionality in a multi-function application. In response, the mobile device 114 (or other computing device) determines its location and accesses relevant map data in operation 904. The mobile device 114 then displays a map view and user interface in operation 906, such as for example illustrated in FIG. 7A and FIG. 8A. The appearance of the map view is based on a default zoom level and tilt angle as specified in the particular application 106.

User input tilting or zooming the view is then received by the mobile device 114 in operation 908. If the user input is to tilt the map view, the mobile device 114 tilts the appearance of the map view (but does not zoom it) in operation 910 based on the amount of user input received. The method then returns to operation 908 for the receipt of further user input. If zoom input is received in operation 908, the mobile device 114 in operation 908 determines whether the current zoom level and tilt angle are on a system-defined zoom-tilt line such as zoom-tilt lines 502, 602, If so, mobile device 114 determines the amount of tilt that is to occur using the slope of the zoom-tilt line in operation 914. The mobile device 114 then tilts and zooms the map view in operation 916 based on the amount of user zoom input received and the slope of the defined zoom-tilt line. The method then returns to operation 908 for the receipt of further input.

If the mobile device 114 determines in operation 912 that the current zoom level and tilt angle are not on a system-defined zoom-tilt line, but is instead at a custom zoom-tilt point, the flowchart 900 proceeds to operation 918 where the mobile device 114 determine if the custom zoom-tilt point is between two adjacent transition points on the zoom-tilt line. If not, the mobile device 114 causes the map view to zoom but not tilt, based on the amount of user zoom input received. This zooming continues either until the zoom-tilt values are between two adjacent transitions points or user input ceases. If user input ceases the method returns to operation 908 for the receipt of further input.

If the mobile device 114 determines in operation 918 that the custom zoom-tilt point is between two adjacent transition points on the zoom-tilt line, the mobile device 114 determines the zoom-tilt slope to the next transition point in the direction of zoom input in operation 922.

The zoom-tilt slope is the rate of change of tilt in response to user zoom input, and is determined by dividing the difference between the tilt angle of the next transition point and the tilt angle of the current zoom-tilt point by the difference between the zoom level of the next transition point and the zoom level of the current zoom-tilt point.

The mobile device 114 then tilts and zooms the map view in operation 924 based on the amount of user zoom input received and the slope that has been determined for the zoom-tilt line between the current point and the next transition point. This zooming and associated tilting performed by the mobile device 114 continue in operation 924 until the direction of zoom input changes, the zoom-tilt values reach the next transition point, or user input ceases, at which point the flowchart returns to operation 908 for the receipt of further input.

If user input ceases during any of the operations, the flowchart 900 returns to operation 908. Other mapping functions, such as updating the view based on a change in the location of the device, the provision of navigation instructions, receiving search queries and reporting map-based searches, and performing any other updates to the view to add or remove information based on changing circumstances or the zoom level that are performed by the mobile device 114, continue in parallel with the flowchart 900. Flowchart 900 continues until the user exits the mapping functionality.

In another example, instead of checking whether the current zoom-tilt point is between two adjacent transition points in operation 918, the mobile device 114 checks whether the current zoom-tilt point is within the upper and lower bounds of the zoom-tilt line. If not, the view is zoomed, but not tilted, by the mobile device 114 in operation 920, based on the amount of user zoom input received.

In another example, if the current zoom-tilt point is determined by the mobile device 114 not to be between two adjacent transition points in operation 918, the tilting of the view towards the next transition point in the direction of zoom by the mobile device 114 view begins immediately, or alternatively remains constant until it reaches the zoom level associated with the next transition point, at which point the view begins tilting towards the next transition point in the direction of zoom.

### MACHINE ARCHITECTURE

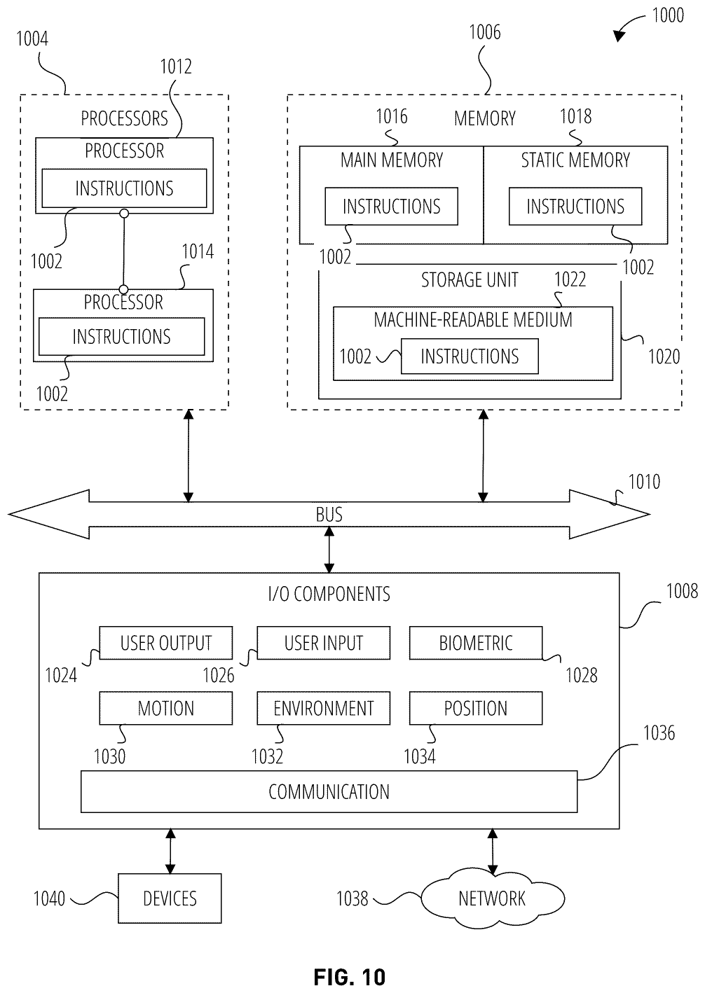

FIG. 10 is a diagrammatic representation of the machine 1000 within which instructions 1002 (e.g., software, a program, an application, an applet, an app, or other executable code) for causing the machine 1000 to perform any one or more of the methodologies discussed herein may be executed. For example, the instructions 1002 may cause the machine 1000 to execute any one or more of the methods described herein. The instructions 1002 transform the general, non-programmed machine 1000 into a particular machine 1000 programmed to carry out the described and illustrated functions in the manner described. The machine 1000 may operate as a standalone device or may be coupled (e.g., networked) to other machines. In a networked deployment, the machine 1000 may operate in the capacity of a server machine or a client machine in a server-client network environment, or as a peer machine in a peer-to-peer (or distributed) network environment. The machine 1000 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 1002, sequentially or otherwise, that specify actions to be taken by the machine 1000. Further, while a single machine 1000 is illustrated, the term “machine” shall also be taken to include a collection of machines that individually or jointly execute the instructions 1002 to perform any one or more of the methodologies discussed herein. The machine 1000, for example, may comprise the user system 102 or any one of multiple server devices forming part of the server system 110. In some examples, the machine 1000 may also comprise both client and server systems, with certain operations of a particular method or algorithm being performed on the server-side and with certain operations of the method or algorithm being performed on the client-side.

The machine 1000 may include one or processors 1004 (such as processor 1012, processor 1014 and so forth), memory 1006, and input/output I/O components 1008, which may be configured to communicate with each other via a bus 1010.

The memory 1006 includes a main memory 1016, a static memory 1018, and a storage unit 1020, both accessible to the processors 1004 via the bus 1010. The main memory 1006, the static memory 1018, and storage unit 1020 store the instructions 1002 embodying any one or more of the methodologies or functions described herein. The instructions 1002 may also reside, completely or partially, within the main memory 1016, within the static memory 1018, within machine-readable medium 1022 within the storage unit 1020, within at least one of the processors 1004 (e.g., within the processor's cache memory), or any suitable combination thereof, during execution thereof by the machine 1000.

The I/O components 1008 may include a wide variety of components to receive input, provide output, produce output, transmit information, exchange information, capture measurements, and so on. The specific I/O components 1008 that are included in a particular machine will depend on the type of machine. For example, portable machines such as mobile phones may include a touch input device or other such input mechanisms, while a headless server machine will likely not include such a touch input device. It will be appreciated that the I/O components 1008 may include many other components that are not shown in FIG. 10. In various examples, the I/O components 1008 may include user output components 1024 and user input components 1026. The user output components 1024 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 1026 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 1008 may include biometric components 1028, motion components 1030, environmental components 1032, or position components 1034, among a wide array of other components. The motion components 1030 include acceleration sensor components (e.g., accelerometer), gravitation sensor components, rotation sensor components (e.g., gyroscope).

The environmental components 1032 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

With respect to cameras, the user system 102 may have a camera system comprising, for example, front cameras on a front surface of the user system 102 and rear cameras on a rear surface of the user system 102. The front cameras may, for example, be used to capture still images and video of a user of the user system 102 (e.g., “selfies”), which may then be modified with digital effect data (e.g., filters) described above. The rear cameras may, for example, be used to capture still images and videos in a more traditional camera mode, with these images similarly being modified with digital effect data. In addition to front and rear cameras, the user system 102 may also include a 360° camera for capturing 360° photographs and videos.

Moreover, the camera system of the user system 102 may be equipped with advanced multi-camera configurations. This may include dual rear cameras, which might consist of a primary camera for general photography and a depth-sensing camera for capturing detailed depth information in a scene. This depth information can be used for various purposes, such as creating a bokch effect in portrait mode, where the subject is in sharp focus while the background is blurred. In addition to dual camera setups, the user system 102 may also feature triple, quad, or even penta camera configurations on both the front and rear sides of the user system 102. These multiple cameras systems may include a wide camera, an ultra-wide camera, a telephoto camera, a macro camera, and a depth sensor, for example.

Communication may be implemented using a wide variety of technologies. The I/O components 1008 further include communication components 1036 operable to couple the machine 1000 to a network 1038 or devices 1040 via respective coupling or connections. For example, the communication components 1036 may include a network interface component or another suitable device to interface with the network 1038. In further examples, the communication components 1036 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1040 may be another machine or any of a wide variety of peripheral devices (e.g., a peripheral device coupled via a USB).

Moreover, the communication components 1036 may detect identifiers or include components operable to detect identifiers. For example, the communication components 1036 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph™, MaxiCode, PDF417, Ultra Code, UCC RSS-2D bar code, and other optical codes), or acoustic detection components (e.g., microphones to identify tagged audio signals). In addition, a variety of information may be derived via the communication components 1036, such as location via Internet Protocol (IP) geolocation, location via Wi-Fi® signal triangulation, location via detecting an NFC beacon signal that may indicate a particular location, and so forth.

The various memories (e.g., main memory 1016, static memory 1018, and memory of the processors 1004) and storage unit 1020 may store one or more sets of instructions and data structures (e.g., software) embodying or used by any one or more of the methodologies or functions described herein. These instructions (e.g., the instructions 1002), when executed by processors 1004, cause various operations to implement the disclosed examples.

The instructions 1002 may be transmitted or received over the network 1038, using a transmission medium, via a network interface device (e.g., a network interface component included in the communication components 1036) and using any one of several well-known transfer protocols (e.g., hypertext transfer protocol (HTTP)). Similarly, the instructions 1002 may be transmitted or received using a transmission medium via a coupling (e.g., a peer-to-peer coupling) to the devices 1040.

### SOFTWARE ARCHITECTURE

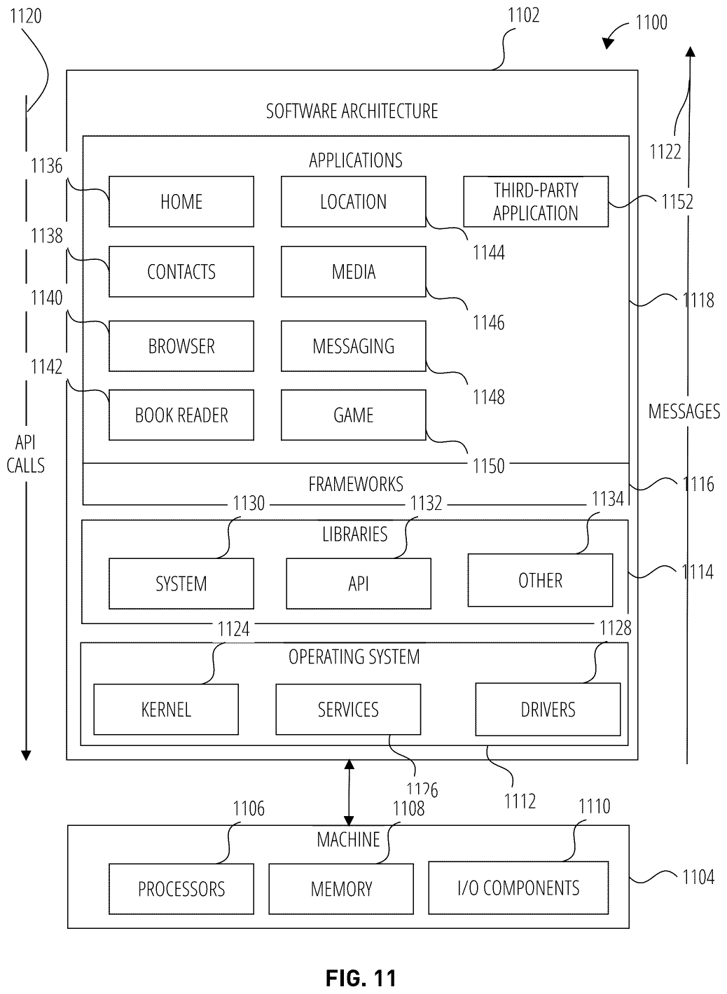

FIG. 11 is a block diagram 1100 illustrating a software architecture 1102, which can be installed on any one or more of the devices described herein. The software architecture 1102 is supported by hardware such as a machine 1104 that includes Processors 1106, memory 1108, and I/O components 1110. In this example, the software architecture 1102 can be conceptualized as a stack of layers, where each layer provides a particular functionality. The software architecture 1102 includes layers such as an operating system 1112, libraries 1114, frameworks 1116, and applications 1118. Operationally, the applications 1118 invoke API calls 1120 through the software stack and receive messages 1122 in response to the API calls 1120.

The operating system 1112 manages hardware resources and provides common services. The operating system 1112 includes, for example, a kernel 1124, services 1126, and drivers 1128. The kernel 1124 acts as an abstraction layer between the hardware and the other software layers. For example, the kernel 1124 provides memory management, processor management (e.g., scheduling), component management, networking, and security settings, among other functionalities. The services 1126 can provide other common services for the other software layers. The drivers 1128 are responsible for controlling or interfacing with the underlying hardware. For instance, the drivers 1128 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 1114 provide a common low-level infrastructure used by the applications 1118. The libraries 1114 can include system libraries 1130 (e.g., C standard library) that provide functions such as memory allocation functions, string manipulation functions, mathematical functions, and the like. In addition, the libraries 1114 can include API libraries 1132 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1114 can also include a wide variety of other libraries 1134 to provide many other APIs to the applications 1118.

The frameworks 1116 provide a common high-level infrastructure that is used by the applications 1118. For example, the frameworks 1116 provide various graphical user interface (GUI) functions, high-level resource management, and high-level location services. The frameworks 1116 can provide a broad spectrum of other APIs that can be used by the applications 1118, some of which may be specific to a particular operating system or platform.

In an example, the applications 1118 may include a home application 1136, a contacts application 1138, a browser application 1140, a book reader application 1142, a location application 1144, a media application 1146, a messaging application 1148, a game application 1150, and a broad assortment of other applications such as a third-party application 1152. The applications 1118 are programs that execute functions defined in the programs. Various programming languages can be employed to create one or more of the applications 1118, structured in a variety of manners, such as object-oriented programming languages (e.g., Objective-C, Java, or C++) or procedural programming languages (e.g., C or assembly language). In a specific example, the third-party application 1152 (e.g., an application developed using the ANDROID™ or IOS™ software development kit (SDK) by an entity other than the vendor of a platform) may be mobile software running on a mobile operating system such as IOS™, ANDROID™, WINDOWS® Phone, or another mobile operating system. In this example, the third-party application 1152 can invoke the API calls 1120 provided by the operating system 1112 to facilitate functionalities described herein.

As used in this disclosure, phrases of the form “at least one of an A, a B, or a C,” “at least one of A, B, or C,” “at least one of A, B, and C,” and the like, should be interpreted to select at least one from the group that comprises “A, B, and C.” Unless explicitly stated otherwise in connection with a particular instance in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

Unless the context clearly requires otherwise, throughout the description and the claims, the words “comprise,” “comprising,” and the like are to be construed in an inclusive sense, as opposed to an exclusive or exhaustive sense, e.g., in the sense of “including, but not limited to.”

As used herein, the terms “connected,” “coupled,” or any variant thereof means any connection or coupling, either direct or indirect, between two or more elements; the coupling or connection between the elements can be physical, logical, or a combination thereof.

Additionally, the words “herein,” “above,” “below,” and words of similar import, when used in this application, refer to this application as a whole and not to any portions of this application. Where the context permits, words using the singular or plural number may also include the plural or singular number respectively.

The word “or” in reference to a list of two or more items, covers all the following interpretations of the word: any one of the items in the list, all the items in the list, and any combination of the items in the list. Likewise, the term “and/or” in reference to a list of two or more items, covers all the following interpretations of the word: any one of the items in the list, all the items in the list, and any combination of the items in the list.

The various features, operations, or processes described herein may be used independently of one another, or may be combined in various ways. All possible combinations and sub-combinations are intended to fall within the scope of this disclosure. In addition, certain method or process blocks may be omitted in some implementations.

Although some examples, e.g., those depicted in the drawings, include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence.

### EXAMPLE STATEMENTS

Various examples are contemplated. Example 1 is a system comprising: at least one processor; at least one memory component storing instructions that, when executed by the at least one processor, cause the at least one processor to perform zoom and tilt operations on a map display based on a predetermined relationship between zooming and tilting, the predetermined relationship being defined by a plurality of zoom-tilt transition points, the operations comprising: displaying a map representation of an area, an appearance of the map representation being based on an initial tilt angle and an initial zoom level; receiving user tilt input to tilt the map representation to a user-selected tilt angle; updating the display of the map representation based on the user-selected tilt angle; receiving user zoom input to zoom the map representation, the user zoom input including a zoom direction; determining a next zoom-tilt transition point in the predetermined relationship, in the zoom direction; updating a zoom level of the display of the map representation in response to the user zoom input; and updating a tilt level of the display of the map representation in response to the user zoom input at a rate of tilt based on a slope between the initial zoom level and the user-selected tilt angle and the next zoom-tilt transition point.

In Example 2, the subject matter of Example 1 includes, wherein the operations further comprise: upon receiving the user zoom input, initially maintaining the user-selected tilt angle until a current zoom level and the user-selected tilt angle are between two zoom-tilt transition points.

In Example 3, the subject matter of Examples 1-2 includes, wherein the operations further comprise: upon receiving the user zoom input, immediately updating the user-selected tilt angle based on the user zoom input, and slope between the initial zoom level and the user-selected tilt angle and the next zoom-tilt transition point.

In Example 4, the subject matter of Examples 1-3 includes, wherein the user tilt input comprises a vertical swipe on a touchscreen of two touch inputs.

In Example 5, the subject matter of Examples 1˜4 includes, wherein the user zoom input comprises a vertical swipe of a touch input along an edge of a touchscreen.

In Example 6, the subject matter of Example 5 includes, wherein the operations further comprise: displaying an icon next to the touch input of the user zoom input, the icon being dependent on a zoom level.

In Example 7, the subject matter of Examples 1-6 includes, wherein the user tilt input is to a tilt angle that is outside a range defined by the predetermined relationship, and wherein the operations further comprise: instead of updating the display of the map representation at a rate of tilt and zoom upon receiving user zoom input, maintaining the user-selected tilt angle irrespective of the user zoom input.

Example 8 is a method, performed by at least one processor, for perform zoom and tilt operations on a map display based on a predetermined relationship between zooming and tilting, the predetermined relationship being defined by a plurality of zoom-tilt transition points, the method comprising: displaying a map representation of an area, an appearance of the map representation being based on an initial tilt angle and an initial zoom level; receiving user tilt input to tilt the map representation to a user-selected tilt angle; updating the display of the map representation based on the user-selected tilt angle; receiving user zoom input to zoom the map representation, the user zoom input including a zoom direction; determining a next zoom-tilt transition point in the predetermined relationship, in the zoom direction; updating a zoom level of the display of the map representation in response to the user zoom input; and updating a tilt level of the display of the map representation in response to the user zoom input at a rate of tilt based on a slope between the initial zoom level and the user-selected tilt angle and the next zoom-tilt transition point.

In Example 9, the subject matter of Example 8 includes, upon receiving the user zoom input, initially maintaining the user-selected tilt angle until a current zoom level and the user-selected tilt angle are between two zoom-tilt transition points.

In Example 10, the subject matter of Examples 8-9 includes, upon receiving the user zoom input, immediately updating the user-selected tilt angle based on the user zoom input, and slope between the initial zoom level and the user-selected tilt angle and the next zoom-tilt transition point.

In Example 11, the subject matter of Examples 8-10 includes, wherein the user tilt input comprises a vertical swipe on a touchscreen of two touch inputs.

In Example 12, the subject matter of Examples 8-11 includes, wherein the user zoom input comprises a vertical swipe of a touch input along an edge of a touchscreen.

In Example 13, the subject matter of Examples 8-12 includes, displaying an icon next to the touch input of the user zoom input, the icon being dependent on a zoom level.

In Example 14, the subject matter of Examples 8-13 includes, wherein the user tilt input is to a tilt angle that is outside a range defined by the predetermined relationship, and wherein the method further comprises: instead of updating the display of the map representation at a rate of tilt and zoom upon receiving user zoom input, maintaining the user-selected tilt angle irrespective of the user zoom input.

Example 15 is a non-transitory computer-readable storage medium storing instructions that, when executed by at least one processor, cause the at least one processor to perform zoom and tilt operations on a map display based on a predetermined relationship between zooming and tilting, the predetermined relationship being defined by a plurality of zoom-tilt transition points, the operations comprising: displaying a map representation of an area, an appearance of the map representation being based on an initial tilt angle and an initial zoom level; receiving user tilt input to tilt the map representation to a user-selected tilt angle; updating the display of the map representation based on the user-selected tilt angle; receiving user zoom input to zoom the map representation, the user zoom input including a zoom direction; determining a next zoom-tilt transition point in the predetermined relationship, in the zoom direction; updating a zoom level of the display of the map representation in response to the user zoom input; and updating a tilt level of the display of the map representation in response to the user zoom input at a rate of tilt based on a slope between the initial zoom level and the user-selected tilt angle and the next zoom-tilt transition point.

In Example 16, the subject matter of Example 15 includes, wherein the operations further comprise: upon receiving the user zoom input, initially maintaining the user-selected tilt angle until a current zoom level and the user-selected tilt angle are between two zoom-tilt transition points.

In Example 17, the subject matter of Examples 15-16 includes, wherein the operations further comprise: upon receiving the user zoom input, immediately updating the user-selected tilt angle based on the user zoom input, and slope between the initial zoom level and the user-selected tilt angle and the next zoom-tilt transition point.

In Example 18, the subject matter of Examples 15-17 includes, wherein the user tilt input comprises a vertical swipe on a touchscreen of two touch inputs.

In Example 19, the subject matter of Examples 15-18 includes, wherein the user zoom input comprises a vertical swipe of a touch input along an edge of a touchscreen.

In Example 20, the subject matter of Examples 15-19 includes, wherein the user tilt input is to a tilt angle that is outside a range defined by the predetermined relationship, and wherein the operations further comprise: instead of updating the display of the map representation at a rate of tilt and zoom upon receiving user zoom input, maintaining the user-selected tilt angle irrespective of the user zoom input.

Example 21 is at least one machine-readable medium including instructions that, when executed by processing circuitry, cause the processing circuitry to perform operations to implement of any of Examples 1-20. Example 22 is an apparatus comprising means to implement of any of Examples 1-20. Example 23 is a system to implement of any of Examples 1-20. Example 24 is a method to implement of any of Examples 1-20.

### TERM EXAMPLES

“Carrier signal” may include, for example, any intangible medium that can store, encoding, or carrying instructions for execution by the machine and includes digital or analog communications signals or other intangible media to facilitate communication of such instructions. Instructions may be transmitted or received over a network using a transmission medium via a network interface device.

“Client device” may include, for example, any machine that interfaces to a network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Component” may include, for example, a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” may refer to a hardware component implemented using one or more processors. Similarly, the methods described herein may be at least partially Processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” may include, for example, both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Machine storage medium” may include, for example, a single or multiple storage devices and media (e.g., a centralized or distributed database, and associated caches and servers) that store executable instructions, routines, and data. The term shall accordingly be taken to include, but not be limited to, solid-state memories, and optical and magnetic media, including memory internal or external to processors. Specific examples of machine-storage media, computer-storage media, and device-storage media include non-volatile memory, including by way of example semiconductor memory devices, e.g., crasable programmable read-only memory (EPROM), electrically erasable programmable read-only memory (EEPROM), Field-Programmable Gate Arrays (FPGA), flash memory devices, Solid State Drives (SSD), and Non-Volatile Memory Express (NVMe) devices; magnetic disks such as internal hard disks and removable disks; magneto-optical disks; and CD-ROM, DVD-ROM, Blu-ray Discs, and Ultra HD Blu-ray discs. In addition, machine storage medium may also refer to cloud storage services, Network Attached Storage (NAS), Storage Area Networks (SAN), and object storage devices. The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Network” may include, for example, one or more portions of a network that may be an ad hoc network, an intranet, an extranet, a Virtual Private Network (VPN), a Local Area Network (LAN), a Wireless LAN (WLAN), a Wide Area Network (WAN), a Wireless WAN (WWAN), a Metropolitan Area Network (MAN), the Internet, a portion of the Internet, a portion of the Public Switched Telephone Network (PSTN), a Voice over IP (VOIP) network, a cellular telephone network, a 5GTM network, a wireless network, a Wi-Fi® network, a Wi-Fi 6® network, a Li-Fi network, a Zigbee® network, a Bluetooth® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as third Generation Partnership Project (3GPP) including 4G, fifth-generation wireless (5G) networks, Universal Mobile Telecommunications System (UMTS), High Speed Packet Access (HSPA), Long Term Evolution (LTE) standard, others defined by various standard-setting organizations, other long-range protocols, or other data transfer technology.

“Non-transitory computer-readable storage medium” may include, for example, a tangible medium that is capable of storing, encoding, or carrying the instructions for execution by a machine.

“Processor” may include, for example, data processors such as a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), a Quantum Processing Unit (QPU), a Tensor Processing Unit (TPU), a Neural Processing Unit (NPU), a Field Programmable Gate Array (FPGA), another processor, or any suitable combination thereof. The term “processor” may include multi-core processors that may comprise two or more independent processors (sometimes referred to as “cores”) that may execute instructions contemporaneously. These cores can be homogeneous (e.g., all cores are identical, as in multicore CPUs) or heterogeneous (e.g., cores are not identical, as in many modern GPUs and some CPUs). In addition, the term “processor” may also encompass systems with a distributed architecture, where multiple processors are interconnected to perform tasks in a coordinated manner. This includes cluster computing, grid computing, and cloud computing infrastructures. Furthermore, the processor may be embedded in a device to control specific functions of that device, such as in an embedded system, or it may be part of a larger system, such as a server in a data center. The processor may also be virtualized in a software-defined infrastructure, where the processor's functions are emulated in software.

“Signal medium” may include, for example, an intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

“User device” may include, for example, a device accessed, controlled or owned by a user and with which the user interacts perform an action, engagement or interaction on the user device, including an interaction with other users or computer systems.

What is claimed is:

1. A system comprising:
at least one processor;
at least one memory component storing instructions that, when executed by the at least one processor, cause the at least one processor to perform zoom and tilt operations on a map display based on a predetermined relationship between zooming and tilting, the predetermined relationship being defined by a plurality of zoom-tilt transition points, the operations comprising:
displaying a map representation of an area, an appearance of the map representation being based on an initial tilt angle and an initial zoom level;
receiving user tilt input to tilt the map representation to a user-selected tilt angle;
updating the display of the map representation based on the user-selected tilt angle;
receiving user zoom input to zoom the map representation, the user zoom input including a zoom direction;
determining a next zoom-tilt transition point in the predetermined relationship, in the zoom direction;
updating a zoom level of the display of the map representation in response to the user zoom input; and
updating a tilt level of the display of the map representation in response to the user zoom input at a rate of tilt based on a slope between the initial zoom level and the user-selected tilt angle and the next zoom-tilt transition point.

2. The system of claim 1, wherein the operations further comprise:
upon receiving the user zoom input, initially maintaining the user-selected tilt angle until a current zoom level and the user-selected tilt angle are between two zoom-tilt transition points.

3. The system of claim 1, wherein the operations further comprise:
upon receiving the user zoom input, immediately updating the user-selected tilt angle based on the user zoom input, and slope between the initial zoom level and the user-selected tilt angle and the next zoom-tilt transition point.

4. The system of claim 1, wherein the user tilt input comprises a vertical swipe on a touchscreen of two touch inputs.

5. The system of claim 1, wherein the user zoom input comprises a vertical swipe of a touch input along an edge of a touchscreen.

6. The system of claim 5, wherein the operations further comprise:
displaying an icon next to the touch input of the user zoom input, the icon being dependent on a zoom level.

7. The system of claim 1, wherein the user tilt input is to a tilt angle that is outside a range defined by the predetermined relationship, and wherein the operations further comprise:
instead of updating the display of the map representation at a rate of tilt and zoom upon receiving user zoom input, maintaining the user-selected tilt angle irrespective of the user zoom input.

8. A method, performed by at least one processor, for perform zoom and tilt operations on a map display based on a predetermined relationship between zooming and tilting, the predetermined relationship being defined by a plurality of zoom-tilt transition points, the method comprising:
displaying a map representation of an area, an appearance of the map representation being based on an initial tilt angle and an initial zoom level;
receiving user tilt input to tilt the map representation to a user-selected tilt angle;
updating the display of the map representation based on the user-selected tilt angle;
receiving user zoom input to zoom the map representation, the user zoom input including a zoom direction;
determining a next zoom-tilt transition point in the predetermined relationship, in the zoom direction;
updating a zoom level of the display of the map representation in response to the user zoom input; and
updating a tilt level of the display of the map representation in response to the user zoom input at a rate of tilt based on a slope between the initial zoom level and the user-selected tilt angle and the next zoom-tilt transition point.

9. The method of claim 8, further comprising:
upon receiving the user zoom input, initially maintaining the user-selected tilt angle until a current zoom level and the user-selected tilt angle are between two zoom-tilt transition points.

10. The method of claim 8, further comprising:
upon receiving the user zoom input, immediately updating the user-selected tilt angle based on the user zoom input, and slope between the initial zoom level and the user-selected tilt angle and the next zoom-tilt transition point.

11. The method of claim 8, wherein the user tilt input comprises a vertical swipe on a touchscreen of two touch inputs.

12. The method of claim 8, wherein the user zoom input comprises a vertical swipe of a touch input along an edge of a touchscreen.

13. The method of claim 12, further comprising:
displaying an icon next to the touch input of the user zoom input, the icon being dependent on a zoom level.

14. The method of claim 8, wherein the user tilt input is to a tilt angle that is outside a range defined by the predetermined relationship, and wherein the method further comprises:
instead of updating the display of the map representation at a rate of tilt and zoom upon receiving user zoom input, maintaining the user-selected tilt angle irrespective of the user zoom input.

15. A non-transitory computer-readable storage medium storing instructions that, when executed by at least one processor, cause the at least one processor to perform zoom and tilt operations on a map display based on a predetermined relationship between zooming and tilting, the predetermined relationship being defined by a plurality of zoom-tilt transition points, the operations comprising:
displaying a map representation of an area, an appearance of the map representation being based on an initial tilt angle and an initial zoom level;
receiving user tilt input to tilt the map representation to a user-selected tilt angle;
updating the display of the map representation based on the user-selected tilt angle;
receiving user zoom input to zoom the map representation, the user zoom input including a zoom direction;
determining a next zoom-tilt transition point in the predetermined relationship, in the zoom direction;
updating a zoom level of the display of the map representation in response to the user zoom input; and
updating a tilt level of the display of the map representation in response to the user zoom input at a rate of tilt based on a slope between the initial zoom level and the user-selected tilt angle and the next zoom-tilt transition point.

16. The non-transitory computer-readable storage medium of claim 15, wherein the operations further comprise:
upon receiving the user zoom input, initially maintaining the user-selected tilt angle until a current zoom level and the user-selected tilt angle are between two zoom-tilt transition points.

17. The non-transitory computer-readable storage medium of claim 15, wherein the operations further comprise:
upon receiving the user zoom input, immediately updating the user-selected tilt angle based on the user zoom input, and slope between the initial zoom level and the user-selected tilt angle and the next zoom-tilt transition point.

18. The non-transitory computer-readable storage medium of claim 15, wherein the user tilt input comprises a vertical swipe on a touchscreen of two touch inputs.

19. The non-transitory computer-readable storage medium of claim 15, wherein the user zoom input comprises a vertical swipe of a touch input along an edge of a touchscreen.

20. The non-transitory computer-readable storage medium of claim 15, wherein the user tilt input is to a tilt angle that is outside a range defined by the predetermined relationship, and wherein the operations further comprise:
instead of updating the display of the map representation at a rate of tilt and zoom upon receiving user zoom input, maintaining the user-selected tilt angle irrespective of the user zoom input.
